(19) United States
(12) Patent Application Publication
(10) Pub. No.: US 2004/0056545 A1
(43) Pub. Date: Mar. 25, 2004

(54) Gravitational wave imaging

(76) Inventor: Robert ML Baker JR., Playa del Rey, CA (US)

Correspondence Address: CHRISTIE, PARKER & HALE, LLP, P.O. BOX 7068, PASADENA, CA, 91109-7068, US

(21) Appl. No.: 10/428,490

(22) Filed: May 2, 2003

Related U.S. Application Data
(63) Continuation-in-part of application No. 09/752,975, filed on Dec. 27, 2000.
Application No. 09/752,975 is a continuation-in-part of application No. 09/616,683, filed on Jul. 14, 2000, now Pat. No. 6,417,597.
Application No. 09/616,683 is a continuation-in-part of application No. 09/443,527, filed on Nov. 19, 1999, now Pat. No. 6,160,336.

(51) Int. Cl. H02K 7/02; G01B 1/00; G01C 21/06

(52) U.S. Cl. 310/74; 356/150

(57) ABSTRACT

A gravitational wave generating device is positioned on one side of a material object and a gravitational wave detection device is positioned on the other side of the material object. The intervening material object's texture and internal structure will modify the gravitational wave's polarization, amplitude, speed, frequency, or other characteristics and serve to image the material object's texture and internal structure when the gravitational wave detector on the other side of the material object is connected to a display device. In a preferred embodiment an array of detectors and a gravitational wave lens or lenses can serve to accentuate and concentrate the image of the material object's texture and internal structure. The gravitational waves can also be generated by a celestial background source or sources. Multiple gravitational wave generators and/or detectors, which can be in motion, can be utilized in order to obtain stereoptical, three-dimensional views of the material object's texture and internal structure and to eliminate or screen out unwanted features of the material object.

### CROSS-REFERENCE TO RELATED APPLICATION(S)

This application is a continuation-in-part of U.S. application Ser. No. 09/752,975 filed Dec. 27, 2000 which is a continuation-in-part of U.S. application Ser. No. 09/616,683, filed Jul. 14, 2000, now U.S. Pat. No. 6,417,597, issue date Jul. 9, 2002, which is a continuation-in-part of U.S. application Ser. No. 09/443,527, filed Nov. 19, 1999, now U.S. Pat. No. 6,160,336, issue date Dec. 12, 2000, the disclosures of which are incorporated herein by reference

### BACKGROUND OF THE INVENTION

According to previous scientific analysis, the speed of a gravitational wave is reduced in a superconductor. This analysis leads to utilizing a superconductor, particularly a high-temperature superconductor (HTSC), as a refractive medium. One then can fabricate a lens from such a refractive medium. The use of this type of lens is especially promising for High-Frequency Gravitational Waves (HFGW) since the shorter the wavelength, the less is the diffraction and the greater the resolution. At a one GHz frequency the GW wavelength is 30 [cm] and at one THz it is 0.3 [mm]. The diffraction of HFGW causes a fanning out of the HFGW from any aperture; for example, a spreading out from the aperture at the “end” of a HFGW generator or from the aperture (diameter) of a HFGW lens. Because of diffraction, the image of a point source, such as a distant stellar source of HFGW, is not a point, but spreads out into what is termed a spurious disk, surrounded by alternate concentric rings of the presence or absence (interspace) of HFGW.

### DESCRIPTION OF THE PRIOR ART

Robert ML Baker, Jr. in U.S. Pat. No. 6,417,597, issue date Jul. 9, 2002, which is a continuation-in-part of U.S. Pat. No. 6,160,336, issue date Dec. 12, 2000 and of patent application Ser. No. 09/752,975 Filed Dec. 27, 2000 describes various devices for the generation and detection of gravitational waves. Also described in the '975 application is a lens system for use in focusing and/or concentrating gravitational waves. The primordial or relic cosmic gravitational wave background, which can be utilized as a natural source of gravitational wave illumination, is discussed by R. Brustein, M. Gasperini, M. Giovannini, and G. Veneziano (1995), “Relic gravitational waves from string cosmology”, Physics Letters B, Volume 361 pp. 45-51. The fact that, for example, the speed of gravitational waves can be changed by the material through which it passes is discussed on page 5491 of Ning Li and Douglas G. Torr (1992), “Gravitational effects on the magnetic attenuation of super conductors”, Physical Review B, Volume 46, Number 9.

### SUMMARY OF THE INVENTION

The present invention provides a gravitational wave source or sources on one side of a material object and a gravitational wave detector or detectors on an opposite side together with a display device, such as a computer screen, to image the material object's texture and/or internal structure. The detectors reveal the texture and internal structure of the material object in much the same way as X-rays do in the electromagnetic wave spectrum. In the case of X-rays the electromagnetic radiation is far less penetrating than the gravitational radiation. Gravitational waves can, in fact, propagate directly through the Earth. The source of the gravitational waves can be one or more of the gravitational wave generators described in U.S. Pat. Nos. 6,417,597, 6,160,336, and patent application Ser. No. 09/752,975 filed Dec. 27, 2000. The source can also be the primordial or relic cosmic background or other source or sources. The gravitational wave detector or detectors can be those described in U.S. Pat. No. 6,417,597 and in the '975 application. Multiple gravitational wave generators and/or detectors, which can be in motion relative to the material object, can be utilized to provide a stereoptical or three-dimensional view of the material object's texture and/or internal structure and/or suppress or screen out unwanted features of the material object's texture or internal structure. The gravitational wave generators and/or detectors can be in motion relative to the material object as, for example, being Earth-satellite based.

### BRIEF DESCRIPTION OF THE DRAWINGS

The foregoing features and advantages of the present invention will be more fully understood by reference to the following detailed description of the invention viewed in connection with the accompanying drawings in which

FIG. 1 is a schematic diagram of an imaging gravitational wave system having a source for generating gravitational waves through a material object and which are projected on to a detector connected to a display device.

FIG. 2 is a schematic of the same imaging system as in FIG. 1 with a gravitational wave lens interposed between the gravitational wave source and the material object.

FIG. 3 is a schematic of the same imaging system as in FIG. 2 with a gravitational wave lens interposed between the material object and the detector.

FIG. 4 is a schematic of the same imaging system as in FIG. 1 utilizing two movable gravitational wave generators.

FIG. 5 is a schematic of the same imaging system as in FIG. 1 utilizing two or more movable detectors or arrays of detectors, connected to a display computer which is connected to a display device.

FIG. 6 is a schematic of the same imaging system as in FIG. 1 wherein the source of gravitational waves is a celestial background source.

### DETAILED DESCRIPTION OF THE PREFERRED EMBODIMENT

The present invention utilizes a gravitational wave source or sources on one side of a material object and a gravitational wave detector or detectors on an opposite side together with a display device, which could be a computer screen, to image the material object's texture and/or internal structure.

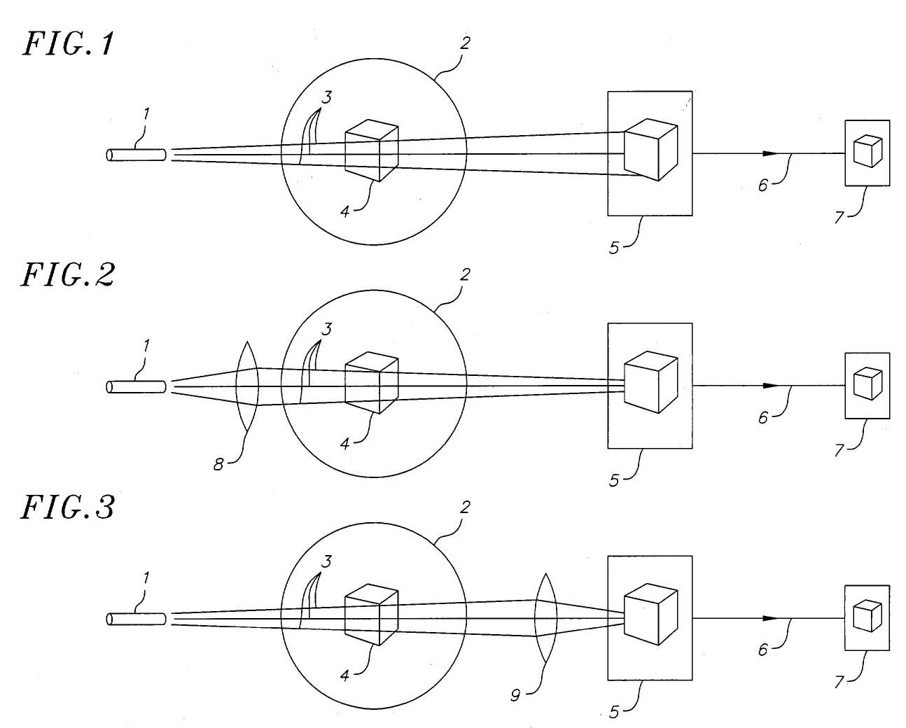

In FIG. 1 a gravitational wave source, such as a gravitational wave generator 1 on one side of a material object 2 generates gravitational waves 3 that are modified by a material object's texture or internal structure 4 and the gravitational waves are projected against a detector or array of detectors 5 that are connected 6 to a display device 7, such as a computer screen, to present an image of the texture or internal structure of the material object created by the modified gravitational waves.

In FIG. 2 a gravitational wave lens 8 is interposed between the gravitational wave generator 1 and the material object 2 in order to accentuate the texture and/or internal structure 4 view of the material object on the display device 7.

In FIG. 3 a gravitational wave lens 9 is disposed between the material object 2 and the detector or array of detectors 5 in order to accentuate the texture and/or internal structure 4 of the material object on the display device 7.

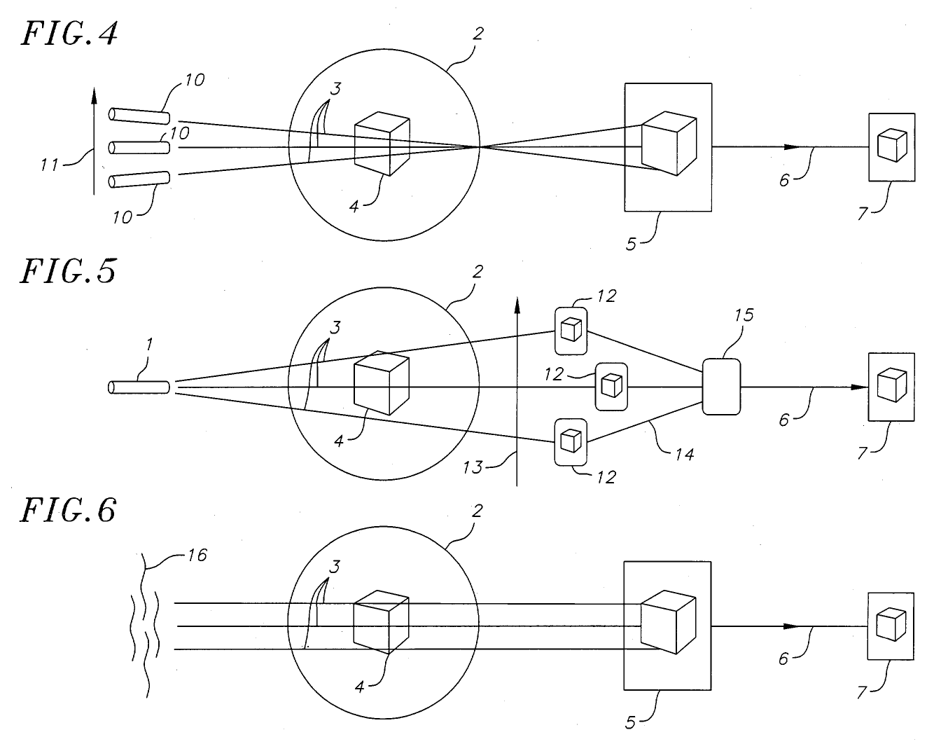

In FIG. 4 there are two or more gravitational wave generators 10, which may be in motion 11 relative to the material object, in order to provide for a three-dimensional of the texture or internal structure of the material object.

In FIG. 5 there are two or more detectors or arrays of detectors 12, which may be in motion 13 relative to the material object and connected 14 via a display computer 15 to a display device 7, such as a computer screen, in order to provide for a three-dimensional view of the texture and/or internal structure of the material object.

In FIG. 6 the gravitational waves are generated by a celestial source 16 such as the relic or primordial cosmic background.

There are several applications of the HFGW refraction property as applied to imaging. These are as follows:

HFGW Telescope

A HFGW Telescope has two major components and a third component is required to test it. The first component is a one to one-hundred-meter diameter multifaceted lens composed of a mosaic of several high-temperature superconductors (tiles) or other media that will refract and focus HFGW. A 10-inch diameter, 0.5-inch thick superconducting disk was fabricated in March 1997 at the University of Alabama. Superconductor Components, Inc. in Columbus, Ohio has fabricated an approximately 6-inch diameter Yttrium-Barium-Copper-Oxide (YB₂C₃O_{7-δ}) or YBCO HTSC disk for NASA to test. For large-diameter HFGW Telescope objective lenses one can utilize far less expensive (though somewhat lower temperature, that is lower than the temperature of liquid Helium that allows YBCO to superconduct) HTSC such as steel-clad MgB₂. Note that since GW can pass through any material without attenuation, such as the detectors on the focal plane (surface) themselves, the slope of the marginal ray through the lens at the image can exceed 90° and can be incident on the “wrong side” of the detector array. Thus focal ratios less than 0.5 might be achieved.

The second component is a HFGW detector (or matrix of detector elements under computer control) placed on the focal plane (or surface) of the HFGW lens. Unlike the Low-Frequency Gravitational (LFGW) detectors such as Cal tech's Laser Interferometric Gravitational Observatory or LIGO (having interferometric-arm dimensions of hundreds or thousands of meters), the HFGW detectors use nanoscale. The third component, needed for optical-bench testing of the HFGW Telescope is the HFGW generator device itself.

HFGW Communication System Lenses

Three types of HFGW communications are contemplated by the present invention. They are interstellar-spacecraft, transglobal, and miniaturized-transceiver local communication.

Interstellar-Spacecraft Communication

In the case of interstellar communications with an interstellar spacecraft at 300 THz (λ_{GW}=10⁻⁶ [m]), a three-meter-diameter transmitter (or HFGW generator) is provided on board the spacecraft. HFGW beam widening will accrue, due to diffraction, like a cone with a 1.22λ_{GW}/width-of-source=1.22×10⁻⁶ [m]/3[m]=4×10⁻7 [radian] apex angle, α_{d}. Thus over a distance of 10 light years or 9.5×101⁶ μl, the signal at the focal plane of the receiving HFGW Telescope will be reduced by a factor of

$$\{ Gathering Power \} \{ Area of Transmitter Beam \} / \{ Area of Beam Spread by Diffraction \} = \{ 7 \times {10}^{15} \} \{ {π ( 3 [ m ] / 2 )}^{2} \} / \{ {π ( 9.5 \times {10}^{16} [ m ] \times 4 \times {10}^{- 7} [ radians ] / 2 )}^{2} \} = 5 \times {10}^{16} / 1.14 \times {10}^{21} = 4.4 \times {10}^{- 5} .$$

From Shannon's [5] equation, C. B. Shannon (1948), Bell Systems Technical Journal, Volume 27, page 623, the maximum information rate, C, is given by

C=Blog₂ (1+S/N)

where B is the band width, say 300 THz or B=3×10¹⁴ [Hz] and the GW flux at the transmitter (or HFGW generator) is 10¹⁰ [watts/m²] so that S=(3×10¹⁰) (4.4×10⁻⁵)=1.32×10⁶ [watts/m²], and with hypothesized noise, N=10⁻8 [watts/m²], we have

C=3×10¹⁴ log₂{1+(1.32×10⁶/10⁻⁸}=3×10¹⁴ {log₂1.32×10¹⁴)} 1.4×10¹⁶ [bps]

or 14 Qbps (Quadra bits per second) maximum information transfer rate.

Transglobal Communication

The approximate bandwidth a HFGW transglobal communication system according to the present invention can achieve is obtained as follows: The distance between a HFGW generating or transmitting device and a receiver or detector is set at about one Earth's radius, 7,000 [km]. For the preferred longitudinal-jerk, linear-motor situation (U.S. Pat. No. 6,417,597) the signal strength, S is calculated. In this device the coherent GW emanates from one end of a 3 [km] diameter HFGW generator and spreads out like a cone (having an apex angle, α_{d}=1.22 cΔt/3 [m]=(4×10⁸) (10⁻¹²)/10×10⁻⁴ [radians]) resulting in an area of n(1×10⁻⁴×7×10⁶/2)²=3.8×10⁵ [m²] some 7000 [cm] away with average of 1[watt/m²]. Thus

S=(1)(0.1)/(3.8×10⁵)=2.5×10⁻⁷ [watts/m²].

n optical system at the 7,000 [km] distant receiver would be utilized. The same optical system as the telescope previously described herein operative at 300 THz, would produce a gain or amplification of 7×10¹⁵ so that the signal at the receiver would be 1.75×10⁶ [watts/m²].

There are several advantages to a HFGW transglobal communication system:

Reduced cost due to avoidance of interconnecting network costs.

Increased bandwidth due to the Quadrahertz or Qbps capability of HFGW. The higher the frequency, the more efficient the GW generation. Moreover the GW spectrum is essentially unlimited.

There will be less interfering noise, e.g., no solar-activity noise, no overhead-power-line noise, no multiple-path ghosts power noise, no multiple-path ghosts.

HFGW will reduce transmission time delay. GW transmits directly through the Earth without circuitous fiber-optic, satellite, or microwave interconnecting networks. The intercontinental one-way time delay will be less than the ratio of the diameter of the Earth divided by the speed of light or 12.8×10⁶/3×10⁸=0.043 [sec] or 43 milliseconds.

Expansion of a HFGW network is inexpensive since there is no need for an interconnecting network.

Through-Material Imaging System

Suppression of the various features of the Earth's interior from near-surface features at or near the lithosphere is contemplated. This is accomplished bby dynamically shifting HFGW frequencies and scanning between HFGW generators distributed around the United States and satellite-borne HFGW detector arrays sweeping up data from the opposite side of the Earth (scanning). Different HFGW frequencies may be scattered, refracted, polarization shifted, etc. by interior features of the Earth differently than from certain interesting features relatively near the Earth's surface or in the ocean—thereby allowing for a “filtering” process. By having different paths between HFGW generated in the United States and the receiving satellite (or satellites) detector arrays could “triangulate” and differentiate between “deep” and “superficial” features in or near the lithosphere.

Lenses for concentrating and focusing the HFGW could be positioned directly in front of the HFGW generator as, 8, in FIG. 2 or near the detection device as, 9, in FIG. 3.

What is claimed is:

1. A system for imaging the texture and/or internal structure of a material object comprising a source of gravitational waves, located on one side of a material object;
a gravitational wave detection device located on the opposite side of the material object and a display device connected to the detection device.

2. A device according to claim 1 wherein a gravitational wave lens is interposed between the gravitational wave source and the material object.

3. A device according to claim 1 wherein a gravitational wave lens is interposed between the material object and the gravitational wave detection device.

4. A device according to claim 1 wherein the source of the gravitational waves is two or more gravitational wave generation devices.

5. A device according to claim 4 wherein the gravitational wave generation devices are in motion.

6. A device according to claim 1 wherein there is a plurality of gravitational wave detection devices are provided.

7. A device according to claim 6 wherein the gravitational wave detection devices are in motion.

8. A device according to claim 1 wherein the gravitational wave source is celestial.
